(19) United States
(12) Patent Application Publication
(10) Pub. No.: US 2025/0265209 A1
(43) Pub. Date: Aug. 21, 2025

(54) HUB DEVICE AND DATA TRANSMISSION METHOD THEREOF

(71) Applicant: Samsung Electronics Co., Ltd., Suwon-si (KR)

(72) Inventors: Changmin HAN, Suwon-si (KR); Yeongjun KWON, Suwon-si (KR); Hyeonggwon KIM, Suwon-si (KR); Kyeong NAMKOONG, Suwon-si (KR); Minjae SHIN, Suwon-si (KR); Huijun SHIM, Suwon-si (KR)

(21) Appl. No.: 19/200,046

(22) Filed: May 6, 2025

Related U.S. Application Data
(63) Continuation of application No. PCT/KR2023/016893, filed on Oct. 27, 2023.

(30) Foreign Application Priority Data
Dec. 15, 2022 (KR) 10-2022-0176337

(51) Int. Cl. G06F 13/38; G06F 1/16

(52) U.S. Cl. CPC G06F 13/382; G06F 1/1632; G06F 2213/0042

(57) ABSTRACT

A hub device may include a first interface including a plurality of USB 2.0 connectors, a second interface including a USB Type-C connector connected to a first electronic device, and one or more processors configured to transmit data received from an first external device connected to a first USB 2.0 connector among the plurality of USB 2.0 connectors to the first electronic device through a first data pin according to USB 2.0 among a plurality of pins of the USB Type-C connector, and transmit data received from a second external device connected to a second USB 2.0 connector among the plurality of USB 2.0 connectors to the first electronic device through a second pin according to USB 2.0 among a plurality of pins of the USB Type-C connector, and the data transmitted to the first electronic device through the second data pin is transmitted to a second electronic device connected to the first electronic device through the first electronic device.

### CROSS-REFERENCE TO RELATED APPLICATIONS

This application is a continuation application of International Application No. PCT/KR2023/016893, designating the United States, filed on Oct. 27, 2023, in the Korean Intellectual Property Receiving Office and claiming priority to Korean Patent Application No. 10-2022-0176337, filed on Dec. 15, 2022, the disclosures of which are all hereby incorporated by reference herein in their entireties.

### BACKGROUND

### Technical Field

Certain example embodiments may relate to a hub device and/or a data transmission method thereof.

### Background Art

Recently, with the development of electronic technology, various types of electronic devices such as monitors, computers, laptops, TVs, etc. are widely used. These electronic devices provide a variety of interfaces for data transmission, enabling data communication between the electronic devices.

One type of interface, the universal serial bus (USB) interface, has developed a USB Type-C specification. In the case of a USB Type-C hub device, various peripheral devices such as a keyboard, a mouse, a gamepad, a joystick, and a storage device can be connected to an electronic device, thereby improving user convenience.

### SUMMARY

A hub device according to an example embodiment may include a first interface including a plurality of USB 2.0 connectors, a second interface including a USB Type-C connector connected, directly or indirectly, to a first electronic device, and one or more processors each comprising processing circuitry. The one or more processors may be individually and/or collectively configured to transmit data received from an first external device connected, directly or indirectly, to a first USB 2.0 connector among the plurality of USB 2.0 connectors to the first electronic device through at least a first data pin according to USB 2.0 among a plurality of pins of the USB Type-C connector. The one or more processors may be individually and/or collectively configured to transmit data received from a second external device connected, directly or indirectly, to a second USB 2.0 connector among the plurality of USB 2.0 connectors to the first electronic device through at least a second pin according to USB 2.0 among a plurality of pins of the USB Type-C connector. The data transmitted to the first electronic device through the second data pin may be transmitted to a second electronic device connected to the first electronic device through at least the first electronic device.

The first data pin may include two pins among a plurality of pins provided on a first side of the USB Type-C connector, and the second data pin may include two pins among a plurality of pins provided on a second side of the USB Type-C connector.

The two pins on the first side may be a D+ pin and a D− pin allocated for USB 2.0 data among the plurality of pins provided on the first side, and the two pins on the second side may be a D+ pin and a D− pin allocated for USB 2.0 data among the plurality of pins provided on the second side.

The first electronic device may include a USB Type-C connector connected to the USB Type-C connector included in the second interface, a third data pin among a plurality of pins of a USB Type-C connector of the first electronic device may be connected to the first data pin, and a fourth data pin among a plurality of pins of a USB Type-C connector of the first electronic device may be connected to the second data pin, and the third data pin and the fourth data pin may not be short-circuited. “Connected” as used herein covers both direct and indirect connections.

The third data pin may include two pins among a plurality of pins provided on a first side of a USB Type-C connector of the first electronic device, and the fourth pin may include two pins among a plurality of pins provided on a second side of a USB Type-C connector of the first electronic device.

The two pins on the first side may be a D+ pin and a D− pin allocated for USB 2.0 data among the plurality of pins provided on the first side, and the two pins on the second side may be a D+ pin and a D− pin allocated for USB 2.0 data among the plurality of pins provided on the second side.

The D+ pin of the third data pin may not be short-circuited to the D+ pin of the fourth data pin, and the D− pin of the third data pin may not be short-circuited to the D− pin of the fourth data pin.

A data transmission method of a hub device including a first interface including a plurality of USB 2.0 connectors and a second interface including a USB Type-C connector connected to a first electronic device according to an example embodiment may include transmitting data received from an first external device connected to a first USB 2.0 connector among the plurality of USB 2.0 connectors to the first electronic device through a first data pin according to USB 2.0 among a plurality of pins of the USB Type-C connector, and transmitting data received from a second external device connected to a second USB 2.0 connector among the plurality of USB 2.0 connectors to the first electronic device through a second pin according to USB 2.0 among a plurality of pins of the USB Type-C connector. The data transmitted to the first electronic device through the second data pin is transmitted to a second electronic device connected to the first electronic device through the first electronic device.

In a computer-readable recording medium storing a computer instruction(s) that when executed by one or more processors of a hub device including a first interface including a plurality of USB 2.0 connectors and a second interface including a USB Type-C connector connected to a first electronic device, may cause the source device to perform operations, the operations include transmitting data received from an first external device connected to a first USB 2.0 connector among the plurality of USB 2.0 connectors to the first electronic device through a first data pin according to USB 2.0 among a plurality of pins of the USB Type-C connector, and transmitting data received from a second external device connected to a second USB 2.0 connector among the plurality of USB 2.0 connectors to the first electronic device through a second pin according to USB 2.0 among a plurality of pins of the USB Type-C connector. The data transmitted to the first electronic device through the second data pin is transmitted to a second electronic device connected to the first electronic device through the first electronic device.

### BRIEF DESCRIPTION OF DRAWINGS

FIGS. 1A and 1B are views provided to explain a hub device according to an example embodiment;

FIG. 2 is a block diagram provided to explain configuration of a hub device according to an example embodiment;

FIGS. 3 and 4 are views provided to explain a pin map of a USB Type-C connector according to an example embodiment;

FIG. 5 is a block diagram provided to explain configuration of a hub device according to an example embodiment;

FIG. 6 is a block diagram provided to explain a first electronic device according to an example embodiment;

FIG. 7 is a view provided to explain an example of a UI screen according to an example embodiment;

FIG. 8 is a view provided to explain a hub device according to an example embodiment;

FIG. 9 is a view provided to explain an example of a UI screen according to an example embodiment;

FIGS. 10A and 10B are views provided to explain a flow of data according to an example embodiment; and

FIG. 11 is a flowchart provided to explain a data transmission method of a hub device according to an example embodiment.

### DETAILED DESCRIPTION

The terms used in the present disclosure will be briefly described before the present disclosure is described in detail.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Thus, the terms used in the embodiments of the disclosure need to be defined on the basis of the meanings of the terms and the overall contents throughout the disclosure rather than simple names of the terms.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

In some cases, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In the present disclosure, one or more processors may control the overall operations of a device (or an electronic device) including the one or more processors. Specifically, the one or more processors may be connected to each configuration of the device to control the overall operations of the device. The one or more processors may consist of one or multiple processors.

The one or more processors, by executing at least one instruction stored in memory, may perform the operation of a device according to various embodiments. The one or more processors may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors may control one or any combination of the other components of the device, and may perform communication-related operations or data processing. The one or more processors may execute at least one program or instruction stored in the memory. For example, the one or more processors may perform a method according to various embodiments by executing at least one instruction stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors may be implemented as a single core processor including a single core, or as one or more multicore processors including a plurality of cores (e.g., homogeneous multicore or heterogeneous multicore). When the one or more processors are implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which one or more processors and other electronic components are integrated, a single-core processor, a multi-core processor, or a core included in a single-core processor or multi-core processor and here, the core may be implemented as CPU, GPU, APU, MIC, DSP, NPU, hardware accelerator, or machine learning accelerator, etc., but the core is not limited to the embodiments of the present disclosure.

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a ‘module’ or a ‘˜er’ may perform at least one function or operation, and be implemented as hardware or software or be implemented as a combination of hardware and software. In addition, a plurality of ‘modules’ or a plurality of ‘˜er’ may be integrated into at least one module and be implemented as at least one processor (not shown) except for a ‘module’ or a ‘˜er’ that needs to be implemented as specific hardware. Thus, each “module” herein may comprise circuitry.

Meanwhile, various elements and regions in the drawings are schematically drawn in the drawings. Therefore, the technical concept of the disclosure is not limited by a relative size or spacing drawn in the accompanying drawings.

Hereinafter, an embodiment of the present disclosure will be described in greater detail with reference to the accompanying drawings.

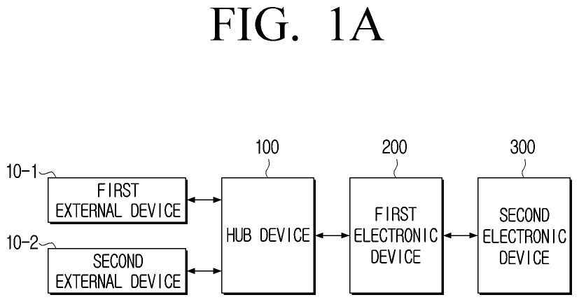

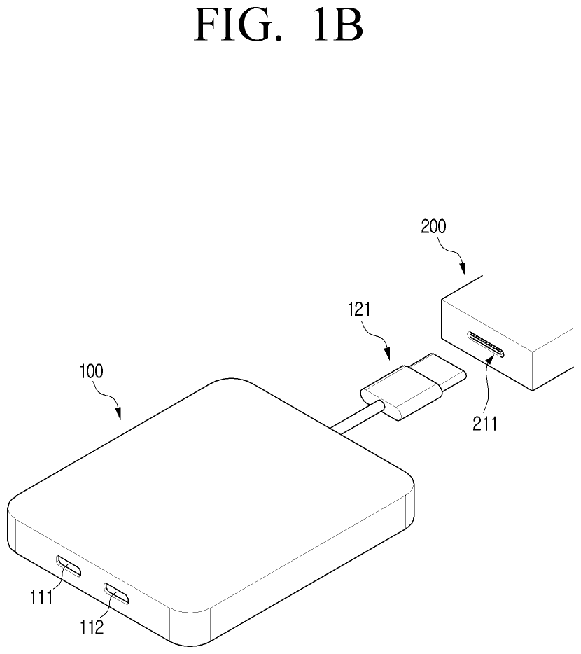

FIGS. 1A and 1B are views provided to explain a hub device according to an embodiment.

Referring to FIGS. 1A and 1B, a hub device 100 is an interface device that enables an electronic device (e.g., monitor, computer, laptop, TV, etc.) to connect to a plurality of peripheral devices (e.g., keyboard, mouse, gamepad, joystick, storage device, etc.).

For example, the hub device 100 may connect a first external device 10-1 and a second external device 10-2 to a first electronic device 200.

To this end, the hub device 100 may include a plurality of USB 2.0 connectors 111, 112. The first external device 10-1 and the second external device 10-2 may be connected to a plurality of USB 2.0 connectors 111, 112, 113. In FIGS. 1A and 1B, the hub device 100 is illustrated as having two USB 2.0 connectors 111, 112, but is not limited thereto. In other words, the hub device 100 may have more than two USB 2.0 connectors.

The hub device 100 may be a USB Type-C hub. The hub device 100 and the first electronic device 200 may be connected through a USB Type-C interface.

To this end, the hub device 100 may include a USB Type-C connector 121. Further, the first electronic device 200 may include a USB Type-C connector 211. The USB Type-C connector 121 and the USB Type-C connector 211 may be connected to each other.

In the case of USB Type-C, the role of the device connected to each connector, e.g., a USB host or a USB device, may be relatively determined. When the hub device 100 and the first electronic device 200 are connected by the USB Type-C connector 121 and the USB Type-C connector 211, the hub device 100 may operate as a USB device, the first electronic device 200 and a second electronic device 300 connected to the first electronic device 200 may operate as a USB host.

Meanwhile, according to an embodiment, the hub device 100 may transmit USB 2.0 data for the first electronic device 200 and USB 2.0 data for the second electronic device 300 to the first electronic device 200 using the USB Type-C connector 121.

Here, data for an electronic device may refer to data processed by an electronic device to control various operations of the electronic device. The USB 2.0 data may refer to data generated in accordance with USB 2.0 standard and transmitted through data pins (e.g., D+ pin, D− pin) of a USB Type-C interface.

To this end, according to an embodiment, a pin map of a USB Type-C connector according to the USB Type-C standard may be reconfigured.

Specifically, two pairs of pins in each of the USB Type-C connector 121 and USB Type-C connector 211 may be allocated for USB 2.0 data.

The hub device 100 may transmit USB 2.0 data for the first electronic device 200 to the first electronic device 200 through a first pair of pins. Further, the hub device 100 may transmit USB 2.0 data for the second electronic device 300 to the first electronic device 200 through the first pairs of pins. In this case, the first electronic device 200 may transmit the received USB 2.0 data to the second electronic device 300.

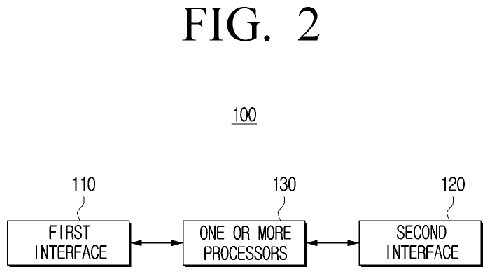

FIG. 2 is a block diagram provided to explain configuration of a hub device according to an embodiment.

Referring to FIG. 2, the hub device 100 may include a first interface 110, a second interface 120, and one or more processors 130.

The first interface 110 may include a plurality of USB 2.0 connectors (111, 112 in FIG. 1B). The first interface 110 may support a USB 2.0 interface. However, the first interface 110 is not limited thereto. For example, the first interface 110 may include a USB 3.0 interface, an HDMI interface, or the like.

The second interface 120 may include a USB Type-C connector (121 in FIG. 1B). The second interface 120 may support a USB Type-C interface. The USB Type-C connector 121 may be connected to the first electronic device (200 in FIG. 1). The USB Type-C connector 121 may be connected to a USB Type-C connector (211 in FIG. 1) of the first electronic device 200.

The one or more processors 130 control the overall operations of the hub device 100. Specifically, the one or more processors 130 may be connected to each configuration of the hub device 100 to control the overall operations of the hub device 100. For example, the one or more processors 130 may be electrically connected to the first interface 110 and the second interface 120 to control the overall operations of the hub device 100. For example, the one or more processors 130 may include at least one hub IC.

Hereinafter, for convenience of explanation, the one or more processors 130 will be referred to as a processor 130.

The processor 130 may transmit data received through the first interface 110 to the first electronic device 200 through the second interface 120.

Specifically, the first interface 110 may include the plurality of USB 2.0 connectors 111, 112. Further, a plurality of external devices may be connected to the plurality of USB 2.0 connectors 111, 112.

Hereinafter, it is assumed that the first external device 10-1 is connected to the first USB 2.0 connector 111 among the plurality of USB 2.0 connectors 111, 112, and the second external device 10-2 is connected to the second USB 2.0 connector 112 among the plurality of USB 2.0 connectors 111, 112.

The processor 130 may receive data from the first external device 10-1 connected to the first USB 2.0 connector 111 and the second external device 10-2 connected to the second USB 2.0 connector 112. Here, the data is USB 2.0 data. For example, USB 2.0 data may be received through data pins of the USB 2.0 connectors 111, 112.

Subsequently, the processor 130 may transmit the data received from the first external device 10-1 and the data received from the second external device 10-2 to the first electronic device 200 through the second interface 120.

Specifically, the processor 130 may transmit data received from the first external device 10-1 to the first electronic device 200 through a first data pin according to USB 2.0 among a plurality of pins of the USB Type-C connector 121. Further, the processor 130 may transmit data received from the second external device 10-2 to the first electronic device 200 through a second data pin according to USB 2.0 among a plurality of pins of the USB Type-C connector 121.

The first data pin may include two of a plurality of pins provided on the first side of the USB Type-C connector 121. The two pins on the first side may be a D+ pin and a D− pin allocated for USB 2.0 data. Further, the second data pin may include two of a plurality of pins provided on the second side of the USB Type-C connector 121. The two pins on the second side may be a D+ pin and a D− pin allocated for USB 2.0 data.

In this case, the first side may be the top side and the second side may be the bottom side. Alternatively, the first side may be the bottom side and the second side may be the top side.

Meanwhile, the USB Type-C connector 211 of the first electronic device 200 may be connected to the USB Type-C connector 121 of the hub device 100.

In this case, a third data pin among the plurality of pins provided on the first side of the USB Type-C connector 211 may be connected to the first data pin of the USB Type-C connector 121. The third data pin may include two of the plurality of pins provided on the first side of the USB Type-C connector 211. The two pins on the first side may be a D+ pin and a D− pin allocated for USB 2.0 data. Further, a fourth data pin among the plurality of pins provided on the second side of the USB Type-C connector 211 may be connected to the second data pin of the USB Type-C connector 121. The fourth data pin may include two of the plurality of pins provided on the second side of the USB Type-C connector 211. The two pins on the second side may be a D+ pin and a D− pin allocated for USB 2.0 data.

In this case, the first side may be the top side and the second side may be the bottom side. Alternatively, the first side may be the bottom side and the second side may be the top side.

The third and fourth data pins may not be short-circuited. In other words, the D+ pin of the third data pin and the D+ pin of the fourth data pin may not be short-circuited, and the D− pin of the third data pin and the D− pin of the fourth data pin may not be short-circuited.

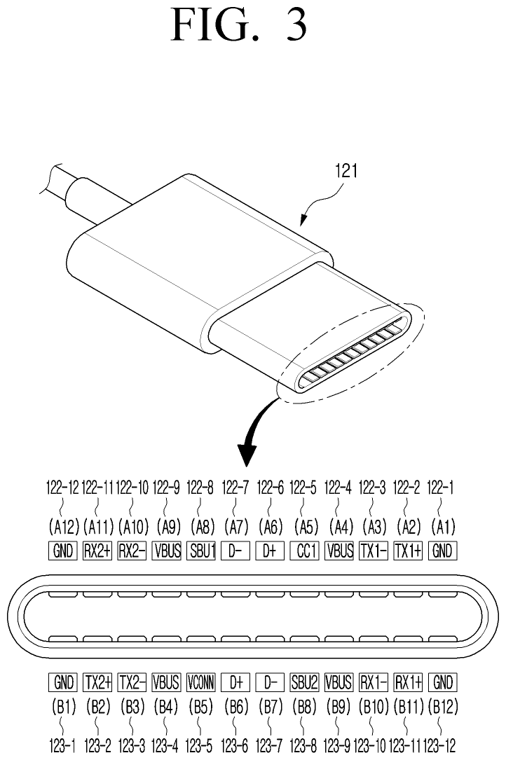

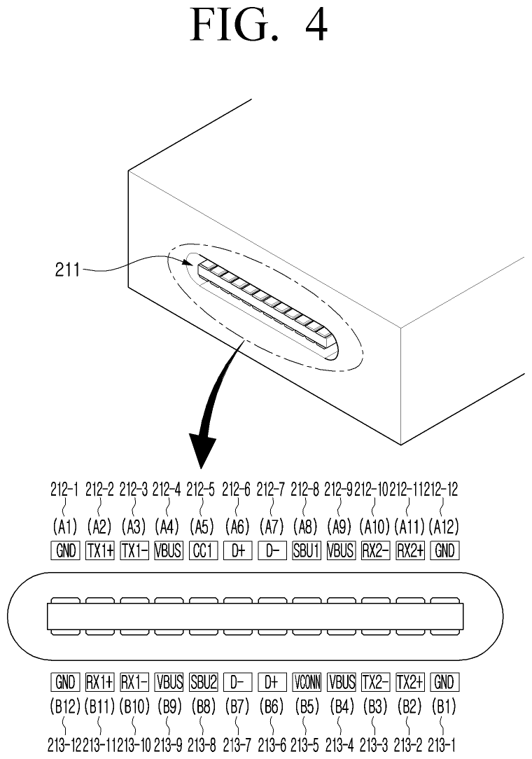

FIGS. 3 and 4 are views provided to explain a pin map of a USB Type-C connector according to an embodiment.

Referring to FIG. 3, the USB Type-C connector 121 of the second interface 120 may include a contact board having a plurality of pins formed thereon. The contact board has 12 pins (A1, A2, . . . , A12) (122-1, 122-2, . . . , 122-12) formed on the top surface (e.g., side A) and 12 pins (B1, B2, . . . , B12) (123-1, 123-2, . . . , 123-12) formed on the bottom surface (e.g., side B).

Meanwhile, the 12 pins on side A may include GND (A1) (122-1), TX1+ (A2) (122-2), TX1− (A3) (122-3), VBUS (A4) (122-4), CC1 (A5) (122-5), D+ (A6) (122-6), D− (A7) (122-7), SBU1 (A8) (122-8), VBUS (A9) (122-9), RX2− (A10) (122-10), RX2+ (A11) (122-11), and GND (A12) (122-12). Further, the 12 pins on side B may include GND (B1) (123-1), TX2+ (B2) (123-2), TX2− (B3) (123-3), VBUS (B4) (123-4), CC2 (or VCONN) (B5) (123-5), D+ (B6) (123-6), D− (B7) (123-7), SBU2 (B8) (123-8), VBUS (B9) (123-9), RX1− (B10) (123-10), RX1+ (B11) (123-11), and GND (B12) (123-12).

Referring to FIG. 4, the USB Type-C connector 211 of the first electronic device 200 may include a contact board having a plurality of pins formed thereon. The contact board may have 12 pins (A1, A2, . . . , A12) (212-1, 212-2, . . . , 212-12) formed on the top surface (e.g., side A) and 12 pins (B1, B2, . . . , B12) (213-1, 213-2, . . . , 213-12) (213-1, 213-2, . . . , 213-12) formed on the bottom surface (e.g., side B).

Meanwhile, the 12 pins on side A may include GND (A1) (212-1), TX1+ (A2) (212-2), TX1− (A3) (212-3), VBUS (A4) (212-4), CC1 (A5) (212-5), D+ (A6) (212-6), D− (A7) (212-7), SBU1 (A8) (212-8), VBUS (A9) (212-9), RX2− (A10) (212-10), RX2+ (A11) (212-11), and GND (A12) (212-12). Further, the 12 pins on side B may include GND (B1) (213-1), TX2+ (B2) (213-2), TX2− (B3) (213-3), VBUS (B4) (213-4), CC2 (or VCONN) (B5) (213-5), D+ (B6) (213-6), D− (B7) (213-7), SBU2 (B8) (213-8), VBUS (B9) (213-9), RX1− (B10) (213-10), RX1+ (B11) (213-11), and GND (B12) (213-12).

Meanwhile, the functions of the pins of the USB Type-C connector 121 and the USB Type-C connector 211 according to an embodiment are shown in Table 1.

TABLE 1

| Pin | Pin | Signal | | |
|---|---|---|---|---|
| No. | No. | Name | Function | Note |
| A1 | B1 | GND | Power | Ground |
| A2 | B2 | TX+ | USB 3.1 or | Super speed TX positive |
| | | | Alternate Mode | |
| A3 | B3 | TX− | USB 3.1 or | Super speed TX negative |
| | | | Alternate Mode | |
| A4 | B4 | VBUS | Power | USB cable charging power |
| A5 | B5 | CC | CC or VCONN | Identification terminal |
| A6 | B6 | D+ | USB 2.0 | +line of the differential |
| | | | | bi-directional USB signal |
| A7 | B7 | D− | USB 2.0 | −line of the differential |
| | | | | bi-directional USB signal |
| A8 | B8 | SBU | Alternate Mode | Side Band Use: additional |
| | | | | purpose pin (ex: Audio |
| | | | | signal, display signal, etc.) |
| A9 | B9 | VBUS | Power | USB cable charging power |
| A10 | B10 | RX− | USB 3.1 or | Super speed RX negative |
| | | | Alternate Mode | |
| A11 | B11 | RX+ | USB 3.1 or | Super speed RX positive |
| | | | Alternate Mode | |
| A12 | B12 | GND | Power | Ground |

Due to reversibility, the 24 pins in the USB Type-C interface may be disposed in a mirrored configuration. In other words, the number of pins of the USB Type-C connector 121 may be the same as the number of pins of the USB Type-C connector 211. Further, the order of arrangement of the 12 pins formed on the top surface and the order of arrangement of the 12 pins formed on the bottom surface in the USB Type-C connector 121 and the USB Type-C connector 211 may be the same. Thus, the USB Type-C connector 121 may be inserted into the USB Type-C connector 211 regardless of directionality.

For example, when the USB Type-C connector 121 is inserted into the USB Type-C connector 211 in a forward direction, the 12 pins (A1, A2, . . . , A12) (122-1, 122-2, . . . , 122-12) of the USB Type-C connector 121 may be in contact with the 12 pins (A1, A2, . . . , A12) (212-1, 212-2, . . . , 212-12) of the USB Type-C connector 211. Further, the 12 pins (B1, B2, . . . , B12) (123-1, 123-2, . . . , 123-12) of the USB Type-C connector 121 may be in contact with the 12 pins (B1, B2, . . . , B12) (213-1, 213-2, . . . , 213-12) of the USB Type-C connector 211.

For example, when the USB Type-C connector 121 is inserted into the USB Type-C connector 211 in a reverse direction, the 12 pins (A1, A2, . . . , A12) (122-1, 122-2, . . . , 122-12) of the USB Type-C connector 121 may in contact with the 12 pins (B1, B2, . . . , B12) (213-1, 213-2, . . . , 213-12) of the USB Type-C connector 211. Further, the 12 pins (B1, B2, . . . , B12) (123-1, 123-2, . . . , 123-12) of the USB Type-C connector 121 may be in contact with the 12 pins (A1, A2, . . . , A12) (212-1, 212-2, . . . , 212-12) of the USB Type-C connector 211.

According to an embodiment, two pairs of pins in each of the USB Type-C connector 121 and the USB Type-C connector 211 may be allocated for USB 2.0 data. Specifically, one pair of data pins (e.g., D+ pin (A6) and D− pin (A7)) and one pair of data pins (e.g., D+ pin (B6) and D− pin (B7)) may be allocated for USB 2.0 data.

The processor 130 may transmit USB 2.0 data for the first electronic device 200 to the first electronic device 200 through a pair of data pins (e.g., D+ pin (A6) and D− pin (A7)), and may transmit USB 2.0 data for the second electronic device 300 to the first electronic device 200 through a pair of data pins (e.g., D+ pin (A6) and D− pin (A7)).

Here, data for an electronic device may refer to data processed by the electronic device to control various operations of the electronic device.

The first electronic device 200 may process the USB 2.0 data for the first electronic device 200 received from the hub device 100 to control the operation of the first electronic device 200. For example, when the USB 2.0 data for the first electronic device 200 includes a control signal for controlling the movement of a cursor displayed on a display (not shown) of the first electronic device 200, the first electronic device 200 may move the cursor displayed on the display (not shown) in accordance with the USB 2.0 data.

Further, the first electronic device 200 may transmit the USB 2.0 data for the second electronic device 300 received from the hub device 100 to the second electronic device 300 connected to the first electronic device 200. In this case, the second electronic device 300 may process the USB 2.0 data for the second electronic device 300 received from the first electronic device 200 to control the operation of the second electronic device 300. For example, when the USB 2.0 data for the second electronic device 300 includes a control signal for displaying text on a display (not shown) of the second electronic device 300, the second electronic device 300 may display the text on the display (not shown) in accordance with the USB 2.0 data.

To this end, for each USB 2.0 connector of the hub device 100, one pair of data pins of the USB Type-C connector 121 through which data received via the USB 2.0 connector is transmitted may be preset.

Specifically, the processor 130 may include two hub ICs. For example, the processor 130 may include a first hub IC and a second hub IC.

In this case, the first hub IC may be configured to perform communication with the first electronic device 200 through the D+ pin (A6) and D− pin (A7) of the USB Type-C connector 121. Accordingly, the first hub IC may transmit the USB 2.0 data received through a USB 2.0 connector connected to the first hub IC among a plurality of USB 2.0 connectors to the first electronic device 200 through the D+ pin (A6) and D− pin (A7).

Further, the second hub IC may be configured to perform communication with the first electronic device 200 through the D+ pin (B6) and D− pin (B7) of the USB Type-C connector 121. Accordingly, the second hub IC may transmit the USB 2.0 data received through a USB 2.0 connector connected to the second hub IC among a plurality of USB 2.0 connectors to the first electronic device 200 through the D+ pin (B6) and D− pin (B7).

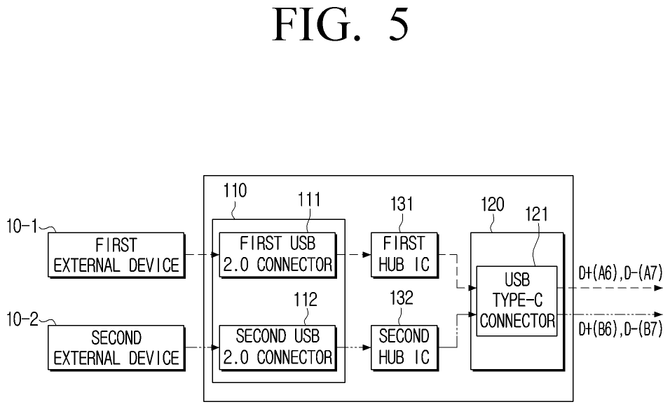

For example, referring to FIG. 5, a first hub IC 131 may transmit the USB 2.0 data received from the first external device 10-1 through the first USB 2.0 connector 111 to the first electronic device 200 through the D+ pin (A6) and D− pin (A7) of the USB Type-C connector 121. Further, a second hub IC 132 may transmit the USB 2.0 data received from the second external device 10-2 through the second USB 2.0 connector 112 to the first electronic device 200 through the D+ pin (B6) and D− pin (B7) of the USB Type-C connector 121.

Meanwhile, in the case of a general USB device, only one pair of data pins out of two pairs of data pins is used to transmit USB 2.0 data to a USB host. In other words, the D+ pin (A6) and D− pin (A7) of the USB Type-C connector of the USB device are allocated for transmitting USB 2.0 data, or the D+ pin (B6) and D− pin (B7) of the USB Type C connector of the USB device are allocated for transmitting USB 2.0 data.

In this case, since the USB Type-C connectors of the USB device and the USB host are connected to each other without directionality, the USB host allocates two pairs of data pins for USB 2.0 data.

For example, it is assumed that the D+ pin (A6) and D− pin (A7) of the USB device are allocated for the transmission of USB 2.0 data. In this case, when the USB Type-C connector of the USB device is inserted into the USB Type-C connector of the USB host in a forward direction, the D+ pin (A6) and D− pin (A7) of the USB device may be in contact with the D+ pin (A6) and D− pin (A7) of the USB host. Also, when the USB Type-C connector of the USB device is inserted into the USB Type-C connector of the USB host in a reverse direction, the D+ pin (A6) and D− pin (A7) of the USB device may be in contact with the D+ pin (B6) and D− pin (B7) of the USB host.

For example, it is assumed that the D+ pin (B6) and D− pin (B7) of the USB device are allocated for the transmission of USB 2.0 data. In this case, when the USB Type-C connector of the USB device is inserted into the USB Type-C connector of the USB host in a forward direction, the D+ pin (B6) and D− pin (B7) of the USB device may be in contact with the D+ pin (B6) and D− pin (B7) of the USB host. Also, when the USB Type-C connector of the USB device is inserted into the USB Type-C connector of the USB host in a reverse direction, the D+ pin (B6) and D− pin (B7) of the USB device may be in contact with the D+ pin (A6) and D− pin (A7) of the USB host.

As such, the data pins allocated for the transmission of USB 2.0 data in the USB Type-C connector of the USB device may be connected to the D+ pin (A6) and D− pin (A7) or the D+ pin (B6) and D− pin (B7) of the USB Type-C connector of the USB host, so the USB host can operate as one data pin by allocating the D+ pin (A6), D− pin (A7) and the D+ pin (B6), D− pin (B7) for USB 2.0 data and shorting them (e.g., shorting the D+ pin (A6) and D+ pin (B6) and shorting the D− pin (A7) and D− pin (B7)).

Due to this structure, the USB device could only transmit USB 2.0 data for one USB host through a USB Type-C connector.

However, according to an embodiment, the pin map of the USB Type-C connector is reconfigured to allow the hub device 100 to transmit USB 2.0 data for the first electronic device 200 and USB 2.0 data for the second electronic device 300 to the first electronic device 200 using the USB Type-C connector 121.

Specifically, two pairs of data pins among a plurality of pins of the USB Type-C connector 121 of the hub device 100 may be allocated for USB 2.0 data. Here, the two pairs of data pins may include one pair of data pins (e.g., D+ pin (A6), D− pin (A7)) and one pair of data pins (e.g., D+ pin (B6), D− pin (B7)).

Further, two pairs of data pins among a plurality of pins of the USB type-C connector 211 of the first electronic device 200 may be allocated for USB 2.0 data. Here, the two pairs of data pins may include one pair of data pins (e.g., D+ pin (A6), D− pin (A7)) and one pair of data pins (e.g., D+ pin (B6), D− pin (B7)). Further, in order for the two pairs of data pins to form different data transmission paths, the D+ pin (A6) and D+ pin (B6) may not be short-circuited, and the D− pin (A7) and D− pin (B7) may not be short-circuited.

Accordingly, the hub device 100 may independently transmit USB 2.0 data to the first electronic device 200 through one pair of data pins of the USB Type-C connector 121 and one pair of data pins. Further, the first electronic device 200 may independently receive USB 2.0 data from the hub device 100 through one pair of data pins of the USB Type-C connector 211 and one pair of data pins.

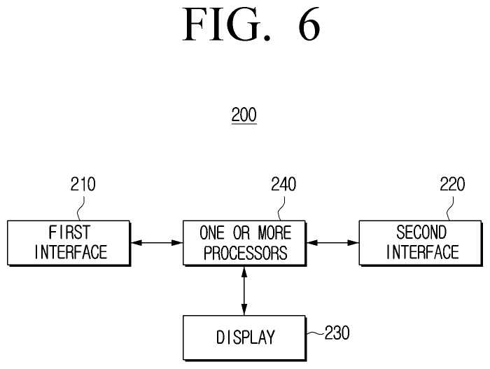

FIG. 6 is a block diagram provided to explain a first electronic device according to an embodiment.

Referring to FIG. 6, the first electronic device 200 may include a first interface 210, a second interface 220, a display 230, and one or more processors 240.

The first interface 210 may include a USB Type-C connector 211. The first interface 210 may support a USB Type-C interface. The USB Type-C connector 211 may be connected to the hub device 100. The USB Type-C connector 211 may be connected to the USB Type-C connector 121 of the hub device 100.

The second interface 220 may be connected to the second electronic device 300. The second interface 220 may support a USB interface. For example, the second interface 220 may include a USB 2.0 interface, a USB 3.0 interface, a USB Type-C interface, or the like.

The display 230 may display an image. To this end, the display 230 may be implemented as various types of displays such as LCD, LED, or OLED. Further, the display 230 may be implemented as a flat display, a curved display, a flexible display capable of folding and/or rolling, and the like.

The one or more processors 240 controls the overall operations of the first electronic device 200. Specifically, the one or more processors 240 may control the overall operations of the first electronic device 200. For example, the one or more processors 240 may be electrically connected to the first interface 210, the second interface 220, and the display 230 to control the overall operations of the first electronic device 200. For example, the one or more processors 240 may include a CPU, GPU, APU, or the like.

Hereinafter, for convenience of explanation, the one or more processors 240 will be referred to as processor 240.

The processor 240 may receive data from the hub device 100. The USB Type-C connector 211 may be connected to the USB Type-C connector 121 of the hub device 100. The processor 240 may receive USB 2.0 data through two data pins provided on a first side and two data pins provided on a second side of the USB Type-C connector 211, respectively. For example, the processor 240 may receive USB 2.0 data through the D+ pin (A6) and D− pin (A7) of the USB Type-C connector 211, and may receive USB 2.0 data through the D+ pin (B6) and D− pin (B7) of the USB Type-C connector 211.

Subsequently, the processor 240 may identify USB 2.0 data for the first electronic device 200 and USB 2.0 data for the second electronic device 300 among the received USB 2.0 data.

For example, the processor 240 may identify USB 2.0 data for the first electronic device 200 and USB 2.0 data for the second electronic device 300 based on a user command to select an electronic device in which USB 2.0 data transmitted by a hub IC is processed for each hub IC.

Specifically, when the USB Type-C connector 121 of the hub device 100 is connected to the USB Type-C connector 211, the processor 240 may receive a PID from a hub IC included in the hub device 100.

As described above, the first hub IC 131 may be configured to perform communication with the first electronic device 200 through the D+ pin (A6) and D− pin (A7) of the USB Type-C connector 121. Thus, the first hub IC 131 may transmit the PID of the first hub IC 131 to the first electronic device 200 through the D+ pin (A6) and D− pin (A7) of the USB Type-C connector 121. Further, the second hub IC 132 may be configured to perform communication with the first electronic device 200 through the D+ pin (B6) and D− pin (B7) of the USB Type-C connector 121. Thus, the second hub IC 132 may transmit the PID of the second hub IC 132 to the first electronic device 200 through the D+ pin (B6) and D− pin (B7) of the USB Type-C connector 121.

In this case, when the USB Type-C connector 121 is inserted into the USB Type-C connector 211 in a forward direction, the D+ pin (A6) and D− pin (A7) of the USB Type-C connector 121 may be in contact with the D+ pin (A6) and D− pin (A7) of the USB Type-C connector 211, and D+ pin (B6) and D− pin (B7) of the USB Type-C connector 121 may be in contact with D+ pin (B6) and D− pin (B7) of the USB Type-C connector 211. Thus, the processor 140 may receive the PID of the first hub IC 131 through the D+ pin (A6) and D− pin (A7) of the USB Type-C connector 211 and the PID of the second hub IC 132 through the D+ pin (B6) and D− pin (B7) of the USB Type-C connector 211.

Further, when the USB Type-C connector 121 is inserted into the USB Type-C connector 211 in a reverse direction, the D+ pin (A6) and D− pin (A7) of the USB Type-C connector 121 may be in contact with the D+ pin (B6) and D− pin (B7) of the USB Type-C connector 211, and the D+ pin (B6) and D− pin (B7) of the USB Type-C connector 121 may be in contact with the D+ pin A6 and D− pin A7 of the USB Type-C connector 211. Thus, the processor 140 may receive the PID of the first hub IC 131 through the D+ pin (B6) and D− pin (B7) of the USB Type-C connector 211 and the PID of the second hub IC 132 through the D+ pin (A6) and D− pin (A7) of the USB Type-C connector 211.

The processor 240 may use the received PID to display a UI screen on the display 230 to receive a user command.

Here, the user command may be a user command for selecting an electronic device in which USB 2.0 data transmitted by the hub IC having the PID (e.g., USB 2.0 data received by the hub IC through a USB 2.0 connector connected to the hub IC) is processed. In this case, the user command may be input through an input interface (not shown) of the first electronic device 200. For example, the input interface may include at least one button.

For example, it is assumed that there is a case where the first electronic device 200 is implemented as a monitor and the second electronic device 300 is implemented as a PC. In this case, the monitor 200 may drive a virtual PC to display a screen provided by the virtual PC, and may display a screen provided by the PC 300.

Also, it is assumed that the PID of the first hub IC 131 is 00xa, and the PID of the second hub IC 132 is 00xb.

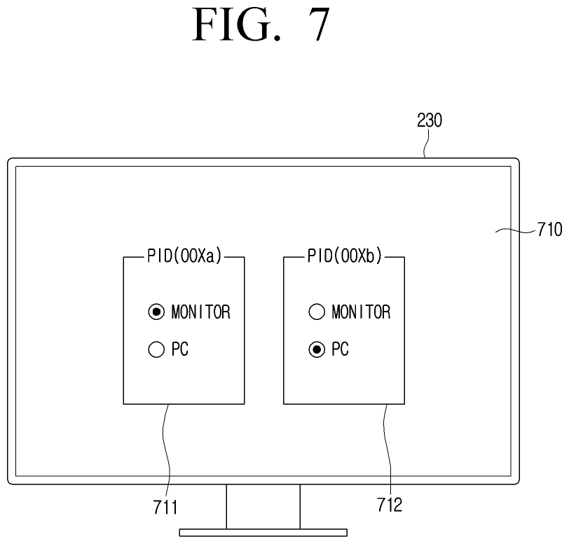

In this case, for example, the processor 240 may control the display 230 to display a UI screen 710 as shown in FIG. 7. The UI screen 710 may include the PID of the first hub IC 131 and the PID of the second hub IC 132. The UI screen 710 may also include menu items 711, 712 for receiving a user command to select one of the monitor 200 and the PC 300 per PID.

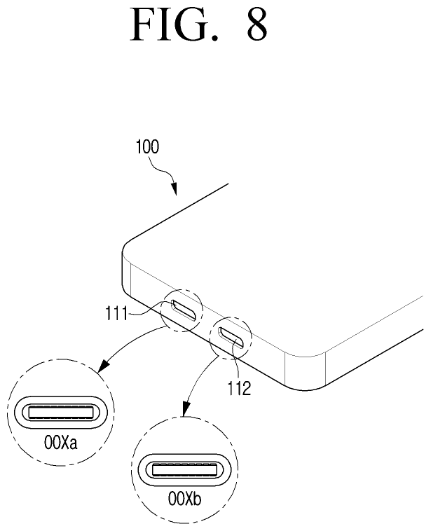

Meanwhile, on one side of the hub device 100, the PID of the hub IC connected to the USB 2.0 connector for each USB 2.0 connector may be displayed. For example, as shown in FIG. 8, the PID (00xa) of the first hub IC 131 to which the first USB 2.0 connector 111 is connected may be described below the first USB 2.0 connector 111, and the PID (00xb) of the second hub IC 132 to which the second USB 2.0 connector 112 is connected may be described below the second USB 2.0 connector 112.

Accordingly, when the user wishes to process the USB 2.0 data generated by the first external device 10-1 connected to the first USB 2.0 connector 111 in the first electronic device 200, the user may select the first electronic device 200 (e.g., a monitor) through the menu item 711, and when the user wishes to process the USB 2.0 data generated by the first external device 10-1 connected to the first USB 2.0 connector 111 in the second electronic device 300, the user may select the second electronic device 300 (e.g., a PC) through the menu item 711.

Further, when the user wishes to process the USB 2.0 data generated by the second external device 10-2 connected to the second USB 2.0 connector 112 in the first electronic device 200, the user may select the first electronic device 200 (e.g., a monitor) through the menu item 712, and when the user wishes to process the USB 2.0 data generated by the second external device 10-2 connected to the second USB 2.0 connector 112 in the second electronic device 300, the user may select the second electronic device 300 (e.g., a PC) through the menu item 712. Here, when the external device is implemented as an input device such as a mouse, a keyboard, or the like, the electronic device may perform various operations by processing the data received from the external device.

Accordingly, the processor 240 may identify USB 2.0 data for the first electronic device 200 and USB 2.0 data for the second electronic device 300 among USB 2.0 data received from the hub device 100 based on the electronic device set for each hub IC based on a user command.

Specifically, when the electronic device in which the USB 2.0 data received from the first hub IC 131 is processed is set to the first electronic device 200, the processor 240 may identify the USB 2.0 data received through one pair of data pins where the PID of the first hub IC 131 is received as data for the first electronic device 200. Further, when the electronic device in which the USB 2.0 data received from the first hub IC 131 is processed is set to the second electronic device 300, the processor 240 may identify the USB 2.0 data received through one pair of data pins where the PID of the first hub IC 131 is received as data for the second electronic device 300.

As described above, depending on whether the USB Type-C connector 121 is inserted into the USB Type-C connector 211 in a forward or reverse direction, the D+ pin (A6) and D− pin (A7) of the USB Type-C connector 121 to which the first hub IC 131 transmits data may be in contact with the D+ pin (A6) and D− pin (A7) or the D+ pin (B6) and D− pin (B7) of the USB Type-C connector 211. Accordingly, the processor 240 may identify the one pair of data pins (D+ pin (A6) and D− pin (A7) or D+ pin (B6) and D− pin (B7)) where the PID of the first hub IC 131 is received, and may identify the USB 2.0 data received through the identified one pair of data pins as data for the first electronic device 200 or data for the second electronic device 300.

Further, when the electronic device in which the USB 2.0 data received from the second hub IC 132 is processed is set to the first electronic device 200, the processor 240 may identify the USB 2.0 data received through one pair of data pins where the PID of the second hub IC 132 is received as data for the first electronic device 200. Further, when the electronic device in which the USB 2.0 data received from the second hub IC 132 is processed is set to the second electronic device 300, the processor 240 may identify the USB 2.0 data received through one pair of data pins where the PID of the second hub IC 132 is received as data for the second electronic device 300.

As described above, depending on whether the USB Type-C connector 121 is inserted into the USB Type-C connector 211 in a forward or reverse direction, the D+ pin (B6) and D− pin (B7) of the USB Type-C connector 121 to which the second hub IC 132 transmits data may be in contact with the D+ pin (A6) and D− pin (A7) or the D+ pin (B6) and D− pin (B7) of the USB Type-C connector 211. Accordingly, the processor 240 may identify the one pair of data pins (D+ pin (A6) and D− pin (A7) or D+ pin (B6) and D− pin (B7)) where the PID of the second hub IC 132 is received, and may identify the USB 2.0 data received through the identified one pair of data pins as data for the first electronic device 200 or data for the second electronic device 300.

According to another embodiment, the processor 240 may identify the USB 2.0 data processed in the first electronic device 200 and the USB 2.0 data transmitted to the second electronic device 300 based on information about the insertion direction in which the USB Type-C connector 121 is inserted into the USB Type-C connector 211, information about the USB 2.0 connector to which the device for each of the first electronic device 200 and the second electronic device 300 is connected, and information about the data pin to which data received through the USB 2.0 connector is transmitted for each of the USB 2.0 connectors of the hub device 100.

To this end, the processor 240 may identify the insertion direction. For example, the insertion direction may be determined based on which CC line is pulled down. The processor 240 may identify the insertion direction by measuring the voltage of an identification terminal (USB_ID), for example, CC1 (A5) (212-5) and/or CC2 (B5) (213-5) of the USB Type-C connector 211. In other words, when a predetermined current is applied to CC1 (A5) (212-5) and CC2 (B5) (213-5), either of CC1 (A5) (212-5) and CC2 (B5) (213-5) may be connected to the CC pin of the USB Type-C connector 121. Accordingly, one of CC1 (A5) (212-5) and CC2 (B5) (213-5) may remain open, and a predetermined voltage may be measured on the other pin. Thus, the processor 240 may measure the voltage on CC1 (A5) (212-5) and/or CC2 (B5) (213-5) to identify whether the USB Type-C connector 121 is inserted into the USB Type-C connector 211 in the forward or reverse direction.

Further, the processor 240 may obtain information about a USB 2.0 connector to which a device for the first electronic device 200 is connected and a USB 2.0 connector to which a device for the second electronic device 300 is connected.

Here, the device for the first electronic device 200 is a device that generates USB 2.0 data for the first electronic device 200, and may include, for example, a device to be used as an input device for the first electronic device 200. Further, the device for the second electronic device 300 may be a device that generates USB 2.0 data for the second electronic device 300, and may include, for example, a device to be used as an input device for the second electronic device 300.

To this end, the processor 240 may display a UI screen for selecting a USB 2.0 connector on the display 230.

For example, it is assumed that there is a case where the first electronic device 200 is implemented as a monitor and the second electronic device 300 is implemented as a PC. In this case, the monitor 200 may drive a virtual PC to display a screen provided by the virtual PC and may display a screen provided by the PC 300.

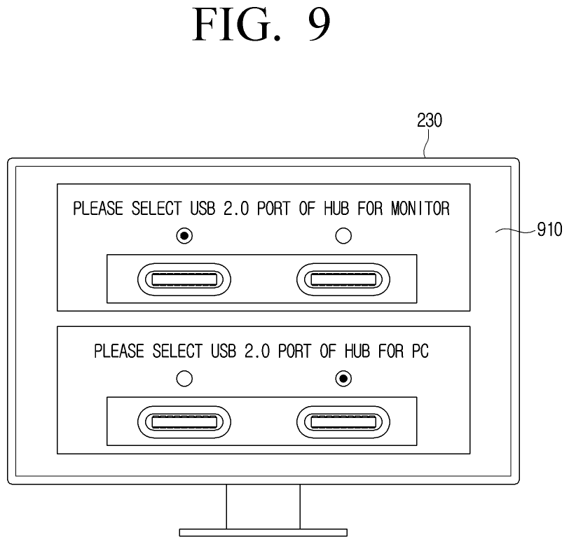

As shown in FIG. 9, for example, the processor 240 may receive, through a UI screen 910, a user command to select a USB 2.0 connector of the hub device 100 to which a device to be used as an input device for the monitor 200 is connected and a user command to select a USB 2.0 connector of the hub device 100 to which a device to be used as an input device for the PC 300 is connected.

To this end, memory (not shown) of the first electronic device 200 may store information about the number and arrangement status of a plurality of USB 2.0 connectors of the hub device 100. The processor 240 may use the stored information to generate a UI screen and, based on a user command input through the UI screen, obtain information about a USB 2.0 connector to which a device for each of the first electronic device 200 and the second electronic device 300 is connected.

In this case, the user command may be input through an input interface (not shown) of the first electronic device 200. For example, the input interface may include at least one button.

Meanwhile, information about a data pin through which data received through a USB 2.0 connector for each USB 2.0 connector of the hub device 100 is transmitted may be stored in the memory (not shown) of the first electronic device 200. Accordingly, the processor 240 may use the information stored in the memory (not shown) to identify through which data pin the hub device 100 transmits the USB 2.0 data received for each USB 2.0 connector to the first electronic device 200.

Accordingly, the processor 240 may identify the USB 2.0 data for the first electronic device 200 and the USB 2.0 data for the second electronic device 300 among the USB 2.0 data received through the D+ pin (A6) and D− pin (A7) of the USB Type-C connector 211 and the USB 2.0 data received through the D+ pin (B6) and D− pin (B7) of the USB Type-C connector 211.

Specifically, the processor 240 may identify USB 2.0 connectors to which the device for the first electronic device 200 and the device for the second electronic device 300 are connected, respectively. In addition, the processor 240 may identify data pins through which the hub device 100 transmits the USB 2.0 data received through the identified USB 2.0 connectors, respectively. Further, the processor 240 may identify the USB 2.0 data for the first electronic device 200 and the USB 2.0 data for the second electronic device 300 by identifying to which data pins of the USB Type C connector 211 the identified data pins are connected according to the insertion direction.

For example, it is assumed that a mouse (not shown) to be used as an input device for the first electronic device 200 is connected to the first USB connector 111, and the hub device 100 transmits USB 2.0 data received from the mouse (not shown) to the first electronic device 200 through the D+ pin (A6) and D− pin (A7) of the USB Type-C connector 121. It is also assumed that a keyboard (not shown) to be used as an input device for the second electronic device 300 is connected to the second USB connector 112, and the hub device 100 transmits USB 2.0 data received from the keyboard (not shown) to the first electronic device 200 through D+ pin (B6) and D− pin (B7) of the USB Type-C connector 121.

In this case, when the USB Type-C connector 121 is inserted into the USB Type-C connector 211 in a forward direction, the processor 240 may identify the USB 2.0 data received through D+ pin (A6) and D− pin (A7) of the USB Type-C connector 211 as data for the first electronic device 200, and may identify the USB 2.0 data received through D+ pin (B6) and D− pin (B7) of the USB Type-C connector 211 as data for the second electronic device 300.

Further, when the USB Type-C connector 121 is inserted into the USB Type-C connector 211 in a reverse direction, the processor 240 may identify the USB 2.0 data received through D+ pin (B6) and D− pin (B7) of the USB Type-C connector 211 as data for the first electronic device 200, and may identify the USB 2.0 data received through D+ pin (A6) and D− pin (A7) of the USB Type-C connector 211 as data for the second electronic device 300.

As such, according to various embodiments, the processor 240 may use various methods to identify data for the first electronic device 200 and data for the second electronic device 300.

Meanwhile, the processor 240 may process data for the first electronic device 200 to perform operations based on the data. Further, the processor 240 may transmit data for the second electronic device 300 to the second electronic device 300 through the second interface 220.

To this end, the first electronic device 200 may include a switching element. In this case, the processor 240 may control the switching element to provide USB 2.0 data for the first electronic device 200 to the processor 240 and USB 2.0 data for the second electronic device 300 to the second interface 220.

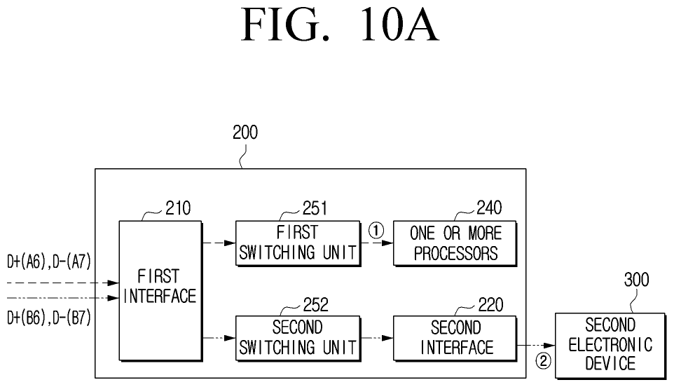

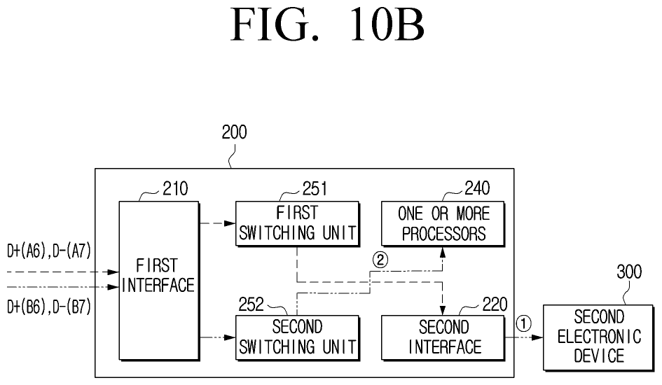

FIGS. 10A and 10B are views provided to explain a flow of data according to an embodiment.

For example, it is assumed that the USB 2.0 data received through D+ pin (A6) and D− pin (A7) of the USB Type-C connector 211 is identified as data for the first electronic device 200, and the USB 2.0 data received through D+ pin (B6) and D− pin (B7) of the Type C connector 211 is identified as data for the second electronic device 300.

In this case, as shown in FIG. 10A, the processor 240 may control first and second switching units 251, 252 to provide the USB 2.0 data received through the D+ pin (A6) and D− pin (A7) to the processor 240 ((1) in FIG. 10A), and to provide the USB 2.0 data received through the D+ pin (B6) and D− pin (B7) to the second interface 220 ((2) in FIG. 10A). Further, the processor 240 may control the second interface 220 to transmit the USB 2.0 data received through the D+ pin (B6) and D− pin (B7) to the second electronic device 300 (2) in FIG. 10A).

For example, it is assumed that the USB 2.0 data received through D+ pin (B6) and D− pin (B7) of the USB Type-C connector 211 is identified as data for the first electronic device 200, and the USB 2.0 data received through D+ pin (A6) and D− pin (A7) of the Type-C connector 211 is identified as data for the second electronic device 300.

In this case, as shown in FIG. 10B, the processor 240 may control the first and second switching units 251, 252 to provide the USB 2.0 data received through the D+ pin (B6) and D− pin (B7) to the processor 240 ((2) in FIG. 10B), and to provide the USB 2.0 data received through the D+ pin (A6) and D− pin (A7) to the second interface 220 (1) in FIG. 10B). Further, the processor 240 may control the second interface 220 to transmit the USB 2.0 data received through the D+ pin (A6) and D− pin (A7) to the second electronic device 300 ((1) in FIG. 10B).

Meanwhile, in the above-described embodiment, the data received through one USB 2.0 connector (e.g., the first USB 2.0 connector 111) is processed in the first electronic device 200 and the data received through one USB 2.0 connector (e.g., the first USB 2.0 connector 112) is processed in the second electronic device 200, but the present disclosure is not limited thereto. In other words, the hub device 100 may also transmit the data received through a plurality of USB 2.0 connectors to the first electronic device 200 through the D+ pin (A6), D− pin (A7) and/or the D+ pin (B6), D− pin (B7) of the USB Type-C connector 121.

For example, the first hub IC 131 may transmit the data received through the plurality of USB 2.0 connectors to the first electronic device 200 through the D+ pin (A6) and D− pin (A7) of the USB Type-C connector. Further, the second hub IC 132 may transmit the data received through the plurality of USB 2.0 connectors to the first electronic device 200 through D+ pin (B6) and D− pin (B7) of the USB Type-C connector 121.

In this case, the first electronic device 200 may identify whether the data received through the D+ pin (A6) and D− pin (A7) and/or the D+ pin (B6), D− pin (B7) of the USB Type-C connector 121 is data for the first electronic device 200 or data for the second electronic device 300. The specific method thereof is the same as described above.

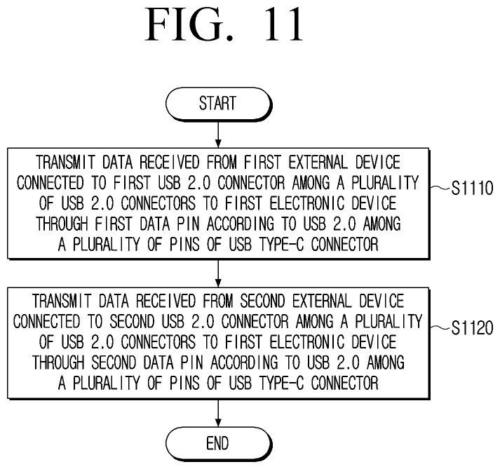

FIG. 11 is a flowchart provided to explain a data transmission method of a hub device according to an embodiment.

The hub device includes a first interface including a plurality of USB 2.0 connectors and a second interface including a USB Type-C connector connectable to a first electronic device.

First, data received from a first external device connected to a first USB 2.0 connector among the plurality of USB 2.0 connectors is transmitted to the first electronic device through a first data pin a in accordance with USB 2.0 among a plurality of pins of the USB Type-C connector (S1110).

Subsequently, data received from a second external device connected to a second USB 2.0 connector among the plurality of USB 2.0 connectors is transmitted to the first electronic device through a second data pin in accordance with USB 2.0 among the plurality of pins of the USB Type-C connector (S1120).

In this case, the data transmitted to the first electronic device through the second data pin is transmitted to a second electronic device connected to the first electronic device through the first electronic device.

Further, the first data pin may include two of the plurality of pins provided on a first side of the USB Type-C connector. The second data pin may include two of the plurality of pins provided on a second side of the USB Type-C connector.

Here, the two pins on the first side may be D+ pin and D− pin allocated for USB 2.0 data among the plurality of pins provided on the first side. The two pins on the second side may be D+ pin and D− pin allocated for USB 2.0 data among the plurality of pins provided on the second side.

Further, the first electronic device may include a USB Type-C connector connected to the USB Type-C connector included in the second interface. A third data pin among the plurality of pins of the USB Type-C connector of the first electronic device may be connected to the first data pin. A fourth data pin among the plurality of pins of the USB Type-C connector of the first electronic device may be connected to the second data pin. Here, the third data pin and the fourth data pin may not be short-circuited.

The third data pin may include two of the plurality of pins provided on the first side of the USB Type-C connector of the first electronic device. The fourth data pin may include two of the plurality of pins provided on the second side of the USB Type-C connector of the first electronic device.

Specifically, the two pins on the first side may be D+ pin and D− pin allocated for USB 2.0 data among the plurality of pins provided on the first side. The two pins of the second side may be D+ pin and D− pin allocated for USB 2.0 data among the plurality of pins provided on the second side.

In this case, the D+ pin of the third data pin may not be short-circuited with the D+ pin of the fourth data pin, and the D− pin of the third data pin may not be short-circuited with the D− pin of the fourth data pin.

Meanwhile, according to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic device (e.g., electronic device A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as memory of a server of a manufacturer, a server of an application store, or a relay server or be temporarily generated.

Further, the above-described various embodiments may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software. Each software may perform one or more functions and operations described in this disclosure.

Meanwhile, computer instructions for performing processing operations of the robot device according to the above-described various embodiments may be stored in a non-transitory computer-readable medium. When being executed by a processor of a specific device, the computer instructions stored in such a non-transitory computer-readable medium allows the specific device to perform processing operations in the electronic device according to the above-described various embodiments. The non-transitory computer-readable medium refers to a medium that stores data semi-permanently and can be read by a device, rather than a medium that stores data for a short period of time, such as registers, caches, memory, etc. Specific examples of the non-transitory computer-readable medium may include CD, DVD, hard disk, Blu-ray disk, USB, memory card, ROM, etc.

Further, the components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

1. A hub device comprising:
a first interface including a plurality of USB 2.0 connectors;
a second interface including a USB Type-C connector connected to a first electronic device; and
one or more processors, comprising processing circuitry, individually and/or collectively configured to:
transmit data received from an first external device connected to a first USB 2.0 connector among the plurality of USB 2.0 connectors to the first electronic device through at least a first data pin according to USB 2.0 among a plurality of pins of the USB Type-C connector; and
transmit data received from a second external device connected to a second USB 2.0 connector among the plurality of USB 2.0 connectors to the first electronic device through at least a second pin according to USB 2.0 among a plurality of pins of the USB Type-C connector,
wherein the hub device is configured so that the data to be transmitted to the first electronic device through at least the second data pin can be transmitted to a second electronic device connected to the first electronic device through at least the first electronic device.

2. The device as claimed in claim 1, wherein the first data pin includes two pins among a plurality of pins provided on a first side of the USB Type-C connector; and
wherein the second data pin includes two pins among a plurality of pins provided on a second side of the USB Type-C connector.

3. The device as claimed in claim 2, wherein the two pins on the first side are a D+ pin and a D− pin allocated for USB 2.0 data among the plurality of pins provided on the first side; and
wherein the two pins on the second side are a D+ pin and a D− pin allocated for USB 2.0 data among the plurality of pins provided on the second side.

4. The device as claimed in claim 2, wherein the first electronic device includes a USB Type-C connector connected to the USB Type-C connector included in the second interface;
wherein a third data pin among a plurality of pins of a USB Type-C connector of the first electronic device is connected to the first data pin;
wherein a fourth data pin among a plurality of pins of a USB Type-C connector of the first electronic device is connected to the second data pin; and
wherein the third data pin and the fourth data pin are not short-circuited.

5. The device as claimed in claim 4, wherein the third data pin includes two pins among a plurality of pins provided on a first side of a USB Type-C connector of the first electronic device; and
wherein the fourth pin includes two pins among a plurality of pins provided on a second side of a USB Type-C connector of the first electronic device.

6. The device as claimed in claim 5, wherein the two pins on the first side are a D+ pin and a D− pin allocated for USB 2.0 data among the plurality of pins provided on the first side; and
wherein the two pins on the second side are a D+ pin and a D− pin allocated for USB 2.0 data among the plurality of pins provided on the second side.

7. The device as claimed in claim 6, wherein the D+ pin of the third data pin is not short-circuited to the D+ pin of the fourth data pin; and
wherein the D− pin of the third data pin is not short-circuited to the D− pin of the fourth data pin.

8. A data transmission method of a hub device including a first interface including a plurality of USB 2.0 connectors and a second interface including a USB Type-C connector connected to a first electronic device, the method comprising:
transmitting data received from an first external device connected to a first USB 2.0 connector among the plurality of USB 2.0 connectors to the first electronic device through at least a first data pin according to USB 2.0 among a plurality of pins of the USB Type-C connector; and
transmitting data received from a second external device connected to a second USB 2.0 connector among the plurality of USB 2.0 connectors to the first electronic device through at least a second pin according to USB 2.0 among a plurality of pins of the USB Type-C connector,
wherein the data transmitted to the first electronic device through the second data pin is transmitted to a second electronic device connected to the first electronic device through the first electronic device.

9. The method as claimed in claim 8, wherein the first data pin includes two pins among a plurality of pins provided on a first side of the USB Type-C connector; and
wherein the second data pin includes two pins among a plurality of pins provided on a second side of the USB Type-C connector.

10. The method as claimed in claim 9, wherein the two pins on the first side are a D+ pin and a D− pin allocated for USB 2.0 data among the plurality of pins provided on the first side; and
wherein the two pins on the second side are a D+ pin and a D− pin allocated for USB 2.0 data among the plurality of pins provided on the second side.

11. The method as claimed in claim 9, wherein the first electronic device includes a USB Type-C connector connected to the USB Type-C connector included in the second interface;
wherein a third data pin among a plurality of pins of a USB Type-C connector of the first electronic device is connected to the first data pin;
wherein a fourth data pin among a plurality of pins of a USB Type-C connector of the first electronic device is connected to the second data pin; and
wherein the third data pin and the fourth data pin are not short-circuited.

12. The method as claimed in claim 11, wherein the third data pin includes two pins among a plurality of pins provided on a first side of a USB Type-C connector of the first electronic device; and
wherein the fourth pin includes two pins among a plurality of pins provided on a second side of a USB Type-C connector of the first electronic device.

13. The method as claimed in claim 12, wherein the two pins on the first side are a D+ pin and a D− pin allocated for USB 2.0 data among the plurality of pins provided on the first side; and
wherein the two pins on the second side are a D+ pin and a D− pin allocated for USB 2.0 data among the plurality of pins provided on the second side.

14. The method as claimed in claim 13, wherein the D+ pin of the third data pin is not short-circuited to the D+ pin of the fourth data pin; and
wherein the D− pin of the third data pin is not short-circuited to the D− pin of the fourth data pin.

15. A system comprising a hub device, a first electronic device, and a second electronic device, the system comprising:
the hub device comprising a first interface including a plurality of USB 2.0 connectors;
the hub device further comprising a second interface including a USB Type-C connector connected to a first electronic device; and
the hub device further comprising one or more processors, comprising processing circuitry, individually and/or collectively configured to:
transmit data received from an first external device connected to a first USB 2.0 connector among the plurality of USB 2.0 connectors to the first electronic device through at least a first data pin according to USB 2.0 among a plurality of pins of the USB Type-C connector; and
transmit data received from a second external device connected to a second USB 2.0 connector among the plurality of USB 2.0 connectors to the first electronic device through at least a second pin according to USB 2.0 among a plurality of pins of the USB Type-C connector,
wherein the data to be transmitted to the first electronic device through at least the second data pin is transmitted to the second electronic device connected to the first electronic device through at least the first electronic device.

16. The system as claimed in claim 15, wherein the first data pin includes two pins among a plurality of pins provided on a first side of the USB Type-C connector; and
wherein the second data pin includes two pins among a plurality of pins provided on a second side of the USB Type-C connector.

17. The system as claimed in claim 16, wherein the two pins on the first side are a D+ pin and a D− pin allocated for USB 2.0 data among the plurality of pins provided on the first side; and
wherein the two pins on the second side are a D+ pin and a D− pin allocated for USB 2.0 data among the plurality of pins provided on the second side.

18. The system as claimed in claim 16, wherein the first electronic device includes a USB Type-C connector connected to the USB Type-C connector included in the second interface;
wherein a third data pin among a plurality of pins of a USB Type-C connector of the first electronic device is connected to the first data pin;
wherein a fourth data pin among a plurality of pins of a USB Type-C connector of the first electronic device is connected to the second data pin; and
wherein the third data pin and the fourth data pin are not short-circuited.

19. The system as claimed in claim 18, wherein the third data pin includes two pins among a plurality of pins provided on a first side of a USB Type-C connector of the first electronic device; and
wherein the fourth pin includes two pins among a plurality of pins provided on a second side of a USB Type-C connector of the first electronic device.

20. The system as claimed in claim 19, wherein the two pins on the first side are a D+ pin and a D− pin allocated for USB 2.0 data among the plurality of pins provided on the first side; and
wherein the two pins on the second side are a D+ pin and a D− pin allocated for USB 2.0 data among the plurality of pins provided on the second side.
